(19) United States
(12) Patent Application Publication
(10) Pub. No.: US 2022/0107585 A1
(43) Pub. Date: Apr. 7, 2022

(54) IMAGE FORMING APPARATUS

(71) Applicant: KYOCERA Document Solutions Inc., Osaka (JP)

(72) Inventors: Takahisa NAKAUE, Osaka-shi (JP); Kotatsu KAWAGUCHI, Osaka-shi (JP); Masahito ISHINO, Osaka-shi (JP); Yukari OTA, Osaka-shi (JP); Tomohiro TAMAKI, Osaka-shi (JP)

(73) Assignee: KYOCERA Document Solutions Inc., Osaka (JP)

(21) Appl. No.: 17/488,656

(22) Filed: Sep. 29, 2021

(30) Foreign Application Priority Data
Oct. 2, 2020 (JP) 2020-167479

(51) Int. Cl. G03G 15/08

(52) U.S. Cl. CPC G03G 15/0812

(57) ABSTRACT

A development device includes a development container, a developer carrier, a regulating blade. The development container contains a non-magnetic one-component developer consisting of a toner only. The regulating blade has a curved part having a radius of curvature of 0.1 mm or more and coming into contact with the roller part. The curved part has an arithmetic average roughness Ra of 0.05 to 0.3 μm. The roller part has a ten-point average roughness Rz of 2 to 4 μm. The roller part has a concave and convex portion, and an average interval Sm between the concave portion and the convex portion is 120 to 290 μm. A Sm/Rz is 30 to 145. A width of a nip area between the regulating blade and the roller part in a circumferential direction of the roller part is 0.1 to 0.95 mm.

### INCORPORATION BY REFERENCE

This application is based on and claims the benefit of priority from Japanese patent application No. 2020-167479 filed on Oct. 2, 2020, which is incorporated by reference in its entirety.

### BACKGROUND

The present disclosure relates to an image forming apparatus using an electrophotographic process, such as a copy machine, a printer and a facsimile, and more particularly, to an image forming apparatus provided with a non-magnetic one-component development type development device.

As the development device used in the image forming apparatus using the electrophotographic process, such as a copy machine, a printer, a facsimile and a multifunctional peripheral, a two-component development type employing a toner and a carrier as a developer and a one-component development type employing a toner only without using a carrier are known.

In the development device of the non-magnetic one-component development type, the toner is conveyed by fine concave and convex formed on a surface of a development roller, and excessive toner is regulated by a regulating blade to form a toner thin layer. In addition, when the toner passes below the regulating blade, the toner is charged by friction with the surface of the development roller. Then, a photosensitive drum is rotated with coming into contact with the development roller, and the toner on the surface of the development roller is supplied to the photosensitive drum by electric field.

The non-magnetic one-component development type eliminates the need of devices such as a magnet, a metal sleeve and the carrier, which are necessary for the two-component development type, and allows to perform a sufficient development using only a DC voltage. That is, a stable development performance can be obtained with a simple and low-cost configuration, so that the non-magnetic one-component development type is positively adopted for a low-speed compact machine mainly.

In the above-described non-magnetic one-component development type, because the toner is applied with high mechanical stress when the toner layer is regulated by the regulating blade, the toner component may adhere (fuse) to the surface of the regulating blade. If the toner adheres to the regulating blade, it becomes impossible to form a uniform toner layer, and a so-called “a thin layer stripe”, in which the toner thin layer becomes locally thin, occurs, and finally, an image failure in which a longitudinally white void is formed on the output image occurs. Especially, when a low temperature fixing toner (a low melting point toner) is employed for energy saving, the thin layer stripe remarkably occurs.

Then, a method for reducing the mechanical stress applied to the toner at the regulating area is proposed. For example, the layer regulating blade may be made of electric conductive member having a rubber elasticity. Alternatively, the developer regulating blade may be configured so as to be shaped in a thin elastic plate and be provided with an elastic member at least at a contact portion with the developer carrier.

When a part or all of the regulating blade is made of elastic material to reduce the regulating pressure in the above-described manner, the mechanical stress applied to the toner is reduced. However, if the regulating pressure is reduced to such an extent that the adhesion of the toner to the surface of the regulating blade can be avoided, the thin toner layer becomes too thick, and the layer unevenness of the toner layer tends to occur, and the toner charge amount also decreases.

### SUMMARY

In accordance with an aspect of the present disclosure, a development device includes a development container, a developer carrier, a regulating blade. The development container contains a non-magnetic one-component developer consisting of a toner only. The developer carrier has a roller part carrying the toner on an outer circumferential surface and a rotational shaft disposed around an axis of the roller part, and comes into pressure contact with an image carrier at a predetermined pressing force. The regulating blade comes into contact with the outer circumferential surface of the roller part of the developer carrier and regulates a thickness of a toner layer formed on the outer circumferential surface of the roller part. The development device is configured to supply the toner to the image carrier on which an electrostatic latent image is formed. The regulating blade has a curved part having a radius of curvature of 0.1 mm or more and coming into contact with the roller part. The curved part has an arithmetic average roughness Ra of 0.05 to 0.3 μm. The roller part has a ten-point average roughness Rz of 2 to 4 μm. The roller part has a concave and convex portion, and an average interval Sm between the concave portion and the convex portion is 120 to 290 μm. A Sm/Rz is 30 to 145. A width of a nip area between the regulating blade and the roller part in a circumferential direction of the roller part is 0.1 to 0.95 mm.

In accordance with an aspect of the present disclosure, an image forming apparatus includes the development device.

The other features and advantages of the present disclosure will become more apparent from the following description. In the detailed description, reference is made to the accompanying drawings, and preferred embodiments of the present disclosure are shown by way of example in the accompanying drawings.

### BRIEF DESCRIPTION OF THE DRAWINGS

FIG. 1 is a side sectional view schematically showing a structure of an image forming apparatus 1 provided with a development part 33 of the present disclosure.

FIG. 2 is a side sectional view schematically showing a structure of the image forming part 30 of the image forming apparatus 1 according to the present embodiment.

FIG. 3 is a plan view showing a contact area between a photosensitive drum 31 and a development roller 331 of a development part 33 viewed from the upper side.

FIG. 4 is an enlarged sectional view showing a contact area between the development roller 331 and a regulating blade 334 in the development part 33.

FIG. 5 is a perspective view showing a nonlinear analyzing result of a curved part 334c of the regulating blade 334.

FIG. 6 is a side view showing the curved part 334c of the regulating blade 334.

FIG. 7 is a view showing a measurement method for surface roughness of the regulating blade 334.

FIG. 8 is a view showing a relationship between a Ra of the regulating blade 334 and a Sm/R of the development roller 331, and a thin layer stripe and a toner thin layer unevenness.

FIG. 9 is a view showing a relationship between a Ra of the regulating blade 334 and a nip width between the regulating blade 334 and the development roller 331, and a thin layer stripe and a toner thin layer unevenness.

FIG. 10 is a graph showing a relationship between a development voltage applied to the development roller 331 and an image density when a surface free energy of the development roller 331 is changed.

### DETAILED DESCRIPTION

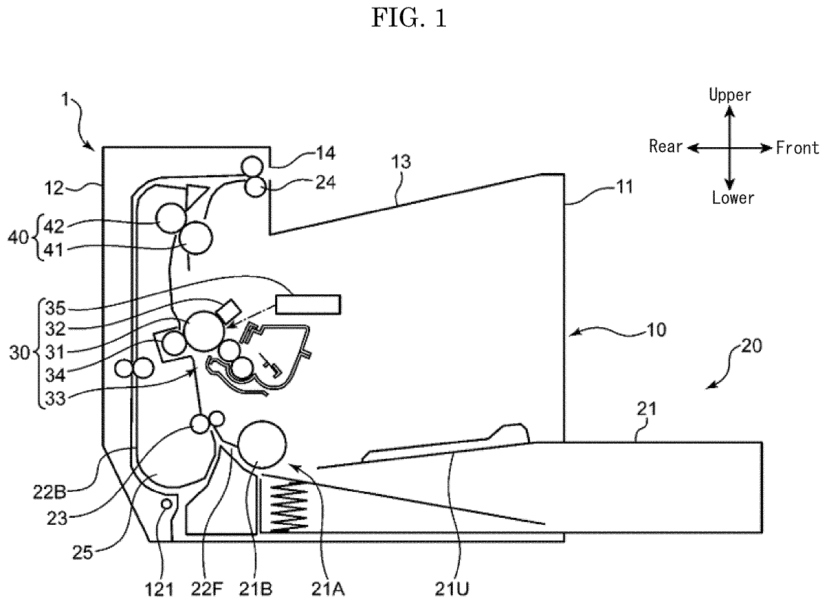

(1. Entire Structure of Image Forming Apparatus 1) Hereinafter, with reference to the attached drawings, one embodiment in the present disclosure will be described. FIG. 1 is a sectional side view schematically showing a structure of an image forming apparatus 1 provided with a development part 33 of the present disclosure. The image forming apparatus 1 (a monochrome printer, in this embodiment) is provided with the development part 33 of the present disclosure. The right side in FIG. 1 is defined as a front side of the image forming apparatus 1 and the left side in FIG. 1 is defined as a rear side of the image forming apparatus 1.

The image forming apparatus 1 includes a main body housing 10 having a housing structure of a substantially rectangular parallelepiped shape, a sheet feeding part 20, an image forming part 30, and a fixing part 40 which are housed in the main body housing 10. A front cover 11 is provided on the front surface of the main body housing 10, and a rear cover 12 is provided on the rear surface of the main body housing 10. Each unit of the image forming part 30 and the fixing part 40 can be attached to and detached from the rear surface side of the main body housing 10 by opening the rear cover 12. On the upper surface of the main body housing 10, a sheet discharge part 13 which discharges the image formed sheet is provided. In the following description, the term “sheet” refers to a copy paper, a coated paper, an OHP sheet, a thick paper, a postcard, a tracing paper, and other sheet materials on which an image forming processing is performed.

The sheet feeding part 20 includes a sheet feeding cassette 21 in which the sheet on which the image forming processing is to be performed is stored. A part of the sheet feeding cassette 21 protrudes further forward from the front surface of the main body housing 10. The upper surface of the sheet feed cassette 21 housed in the main body housing 10 is covered with a sheet feeding cassette top plate 21U. The sheet feeding cassette 21 is provided with a sheet storage space in which a bundle of the sheets is stored, a lift plate which lifts up the bundle of sheets and feeds it, and the others. Above the rear end portion of the sheet feeding cassette 21, a sheet feeding part 21A is provided. In the sheet feeding part 21A, a sheet feeding roller 21B which feeds the uppermost sheet of the bundle of sheets in the sheet feeding cassette 21 one by one is disposed.

The image forming part 30 performs the image forming processing which forms a toner image (a developer image) on the sheet fed from the sheet feeding part 20. The image forming part 30 includes a photosensitive drum 31, a charger 32, an exposure part 35, a development part 33 and a transfer roller 34 which are disposed around the photosensitive drum 31.

The photosensitive drum 31 (an image carrier) includes a rotational shaft and an outer circumferential surface (a drum body) rotating around the rotational shaft. The photosensitive drum 21 is made by, for example, a known organic photosensitive member (OPC), and around the outer circumferential surface of the photosensitive drum 31, a photosensitive layer including a charge generating layer, a charge transporting layer, and the others is formed. The photosensitive layer is uniformly charged by the charger 32 described later, and then is irradiated with light by the exposure part 35 to attenuate the surface potential and to form an electrostatic latent image. Then, on the photosensitive layer, a toner image in which the electrostatic latent image is developed by the development part 33 is carried.

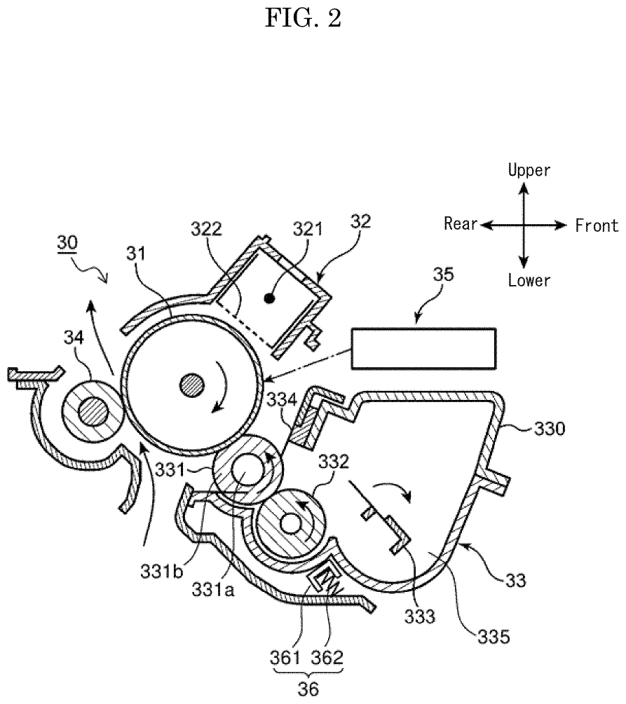

The charger 32 (a charging device) is disposed at a predetermined interval with respect to the outer circumferential surface of the photosensitive drum 31, and uniformly charges the outer circumferential surface of the photosensitive drum 31 in a non-contact state. Specifically, the charger 32 includes a charge wire 321 and a grid electrode 322 (both are shown in FIG. 2). The charge wire 321 is a linear electrode extending in the rotational axis direction of the photosensitive drum 31, and generates corona discharge between the charge wire 321 and the photosensitive drum 31. The grid electrode 322 is a grid-like electrode extending in the rotational axis direction of the photosensitive drum 31, and is disposed between the charge wire 321 and the photosensitive drum 31. The charger 32 generates the corona discharge by flowing a current of a predetermined current value through the charge wire 321, and charges the outer circumferential surface of the photosensitive drum 31 facing the grid electrode 322 to a predetermined surface potential uniformly by applying a predetermined voltage to the grid electrode 322.

The exposure part 35 (an exposure device) includes a laser light source and optical elements such as a mirror and a lens, and irradiates the light modulated based on image data output from an external device, such as a personal computer, on the outer circumferential surface of the photosensitive drum 31. Then, the exposure part 35 forms the electrostatic latent image corresponding to an image based on the image data on the outer circumferential surface of the photosensitive drum 31.

The development part 33 (the development device) is attachable to and detachable from the main body housing 10, and supplies a non-magnetic one-component toner (a developer) to the outer circumferential surface of the photosensitive drum 31 to develop the electrostatic latent image formed on the outer circumferential surface of the photosensitive drum 31. The developing the electrostatic latent image means that a toner image (a developer image) in which the electrostatic latent image is made visible is formed. The development part 33 will be described later in detail.

The transfer roller 34 is a roller which transfers the toner image formed on the outer circumferential surface of the photosensitive drum 31 to the sheet. Specifically, the transfer roller 34 has an outer circumferential surface rotating around an axis and facing the outer circumferential surface of the photosensitive drum 31 on the downstream side of the development roller 331 in the rotational direction of the photosensitive drum 31. The transfer roller 34 transfers the toner image carried on the outer circumferential surface of the photosensitive drum 31 to the sheet passed through a nip area between the transfer roller 34 and the outer circumferential surface of the photosensitive drum 31. At the transferring, the transfer toller 34 is applied with a transfer voltage having a polarity opposite to the toner.

The fixing part 40 performs a fixing processing in which the toner image transferred to the sheet is fixed on the sheet. The fixing part 40 includes a fixing roller 41 and a pressure roller 42. The fixing roller 41 includes a heat source housed therein, and heats the toner transferred to the sheet at a predetermined temperature. The pressure roller 42 is brought into pressure contact with the fixing roller 41 to form a fixing nip area between the fixing roller 41 and the pressure roller 42. When the sheet to which the toner image is transferred is passed through the fixing nip area, the toner image is heated by the fixing roller 41 and pressed by the pressure roller 42 to be fixed on the sheet.

Inside the main body housing 10, a main conveyance path 22F and an inversion conveyance path 22B along which the sheet is conveyed are provided. The main conveyance path 22F extends from the sheet feeding part 21A of the sheet feeding part 20 to a sheet discharge port 14 provided facing the sheet discharge part 13 provided on the upper surface of the main body housing 10 via the image forming part 30 and the fixing part 40. The inversion conveyance path 22B is a conveyance path for returning the sheet formed with the image on one surface to the upstream side of the image forming part 30 on the main conveyance path 22F when the both-side printing is performed on the sheet.

The main conveyance path 22F is extended such that the sheet is conveyed through the transfer nip area between the photosensitive drum 31 and the transfer roller 34 from the lower side to the upper side. On the main conveyance path 22F, a registration rollers pair 23 is disposed on the upstream side of the transfer nip area. The sheet is stopped by the registration rollers pair 23, and then fed to the transfer nip area at a predetermined timing for the image transferring after the skew of the sheet is corrected. At suitable positions on the main conveyance path 22F and the inversion conveyance path 22B, a plurality of conveyance rollers for conveying the sheet is disposed. Near the sheet discharge port 14, a discharge rollers pair 24 is disposed.

The inversion conveyance path 22B is formed between the outer surface of an inversion unit 25 and the inner surface of the rear cover 12 of the main body housing 10. On the inner surface of the inversion unit 25, the transfer roller 34 and one roller of the registration rollers pair 23 are mounted. The rear cover 12 and the inversion unit 25 are rotatable around the supporting point 121 provided in the lower portions thereof. When the sheet jamming occurs on the inversion conveyance path 22B, the rear cover 12 is opened. When the sheet jamming occurs on the main conveyance path 22F, or when the unit of the photosensitive drum 31 or the development part 33 is detached outside, the inversion unit 25 is opened together with the rear cover 12.

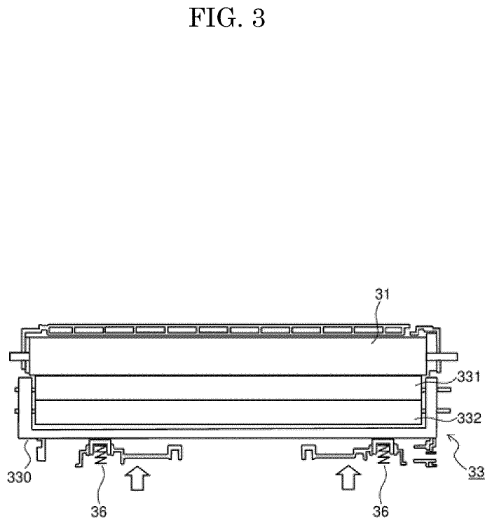

(2. Structure of Image forming Part 30) FIG. 2 is a sectional view showing the image forming part 30 in the image forming apparatus 1 of the present embodiment. FIG. 3 is a plan view showing a contact area between the photosensitive drum 31 and the development roller 331 of the development part 33 viewed from the upper side. FIG. 3 is an enlarged sectional view showing a contact area between the development roller 331 and the regulating blade 334 in the development part 33.

As shown in FIG. 2 and FIG. 3, the development part 33 includes a development housing 330 (a development container), the development roller 331 (a developer carrier), a supply roller 332, an agitating paddle 333 and the regulating blade 334.

The development housing 30 contains a non-magnetic one-component developer consisting of a toner only, and the development roller 331, the supply roller 332 and the regulating blade 334 are stored in the development housing 30. The development housing 330 includes an agitating room 335 in which the developer in an agitated state is contained.

The agitating room 335 contains the non-magnetic one-component developer in an agitated state. In the agitating room 335, the agitating paddle 333 is disposed. The agitating paddle 335 agitates the developer supplied to the agitating room 335 by a toner supply device (not shown).

The development roller 331 has a rotational shaft 331a and a roller part 331b. The rotational shaft 331a is supported by the development housing 330 with bearings (not shown) in a rotatable manner. The roller part 331b is a cylindrical member provided around the outer circumferential surface of the rotational shaft 331a, and has a configuration that a coating layer is laminated on a surface of a base rubber (for example, silicone rubber) with an uneven coating material such as urethane. The roller part 331b is rotated together with the rotational shaft 331a with the rotation of the rotational shaft 331a. On the surface of the roller part 331b, a toner layer (a developer layer) of a predetermined thickness is formed. The thickness of the toner layer is regulated by the regulating blade 334 as described later (regulated uniformly at a predetermined thickness). The toner layer is charged by static electricity generated by contact with the regulating blade 334.

The development roller 331 is rotated in a direction from the upstream side to the downstream side (the counterclockwise direction in FIG. 2) in the rotational direction (the clockwise direction in FIG. 2) of the photosensitive drum 31 at a position facing the photosensitive drum 31. That is, the development roller 331 is rotated in the same direction as the photosensitive drum 31 at the position facing the photosensitive drum 31.

The supply roller 332 is disposed facing the development roller 331. The supply roller 332 carries the developer contained in the agitating room 335 on its outer circumferential surface. In addition, the supply roller 332 supplies the developer carried on the outer circumferential surface to the development roller 331.

The supply roller 332 is rotated in a direction from the downstream side to the upstream side (the counterclockwise direction in FIG. 2) in the rotational direction (the counterclockwise direction in FIG. 2) of the development roller 331 at a position facing the development roller 331. That is, the supply roller 332 is rotated in an opposite direction to the development roller 331 at the position facing the development roller 331.

The development roller 331 is supplied with the developer from the supply roller 332 and carries the toner layer on the outer circumferential surface. Then, the development roller 331 supplies the developer to the photosensitive drum 31. The lengths of the development roller 331 and the supply roller 332 in the axial direction (a direction perpendicular to the paper surface on which FIG. 2 is drawn) is substantially the same as the length of the photosensitive drum 31 in the axial direction. In order to efficiently move the toner from the development roller 331 to the photosensitive drum 31, a predetermined development voltage is preferably applied to the development roller 331.

In the image forming part 30, a pressing mechanism 36 including a pressing member 361 and a pressing spring 362 is disposed on the opposite side (the right lower side in FIG. 2 and the lower side in FIG. 3) to the photosensitive drum 31 with respect to the development housing 330. The pressing mechanisms 36 are disposed at two positions in the longitudinal direction of the development housing 330 (positions separated from the axial center of the photosensitive drum 31 on the both sides by 85 mm respectively). When the development part 33 is attached to the image forming part 30, the pressing member 361 is pressed against the development housing 330 in a direction close to the photosensitive drum 31 (the left upper direction in FIG. 2 and the upper direction in FIG. 3), and the development roller 331 is pressed against the photosensitive drum 31 with a predetermined pressing force. In the development part 33 and the photosensitive drum 31, there is no mechanism for regulating a distance between the development roller 331 and the photosensitive drum 31, that is, a mechanism for regulating the pressing force of the development roller 331 against the photosensitive drum 31.

The regulating blade 334 is a thin metal member. The regulating blade 334 is configured such that the proximal end portion 334a is fixed to the development housing 330 and the distal end portion 334b is a free end. The regulating blade 334 comes into contact with the outer circumferential surface of the development roller 331 at a position upstream of a position where the photosensitive drum 31 and the development roller 331 face each other in the rotational direction of the development roller 331.

The regulating blade 334 is flexibly deformable, and there is a contact area (a nip area) between the regulating blade 334 and the development roller 331 in the circumferential direction of the development roller 331. The regulating blade 334 comes into contact with the outer circumferential surface of the development roller 331 (the roller part 331a) with a predetermined regulating pressure and a nip width W.

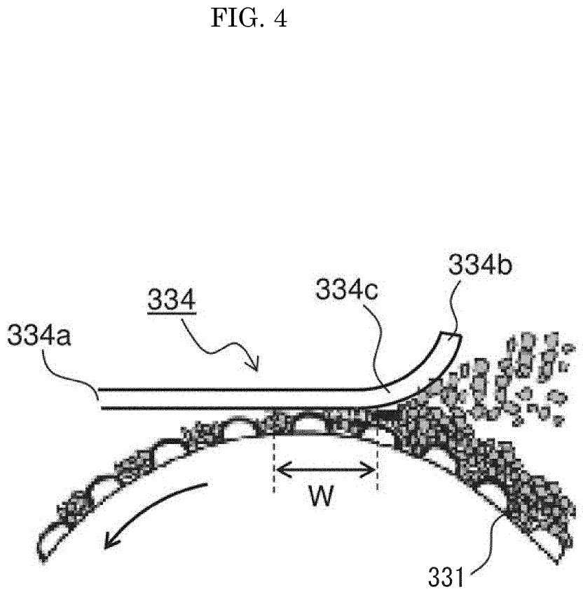

As shown in FIG. 4, because the regulating blade 334 comes into contact with the development roller 331 with a predetermined regulating pressure (a line contact pressure), the toner layer carried on the outer circumferential surface of the development roller 331 is regulated to have a uniform thickness. Thus, the regulating blade 334 regulates an amount of the toner carried on the outer circumferential surface of the development roller 331. Further, the regulating blade 334 is rubbed against the toner carried on the outer circumferential surface of the development roller 334 to charge the toner. The linear contact pressure of the regulating blade 334 on the outer circumferential surface of the development roller 331 is a contact pressure of the regulating blade 334 per unit length at the contact area between the regulating blade 334 and the outer circumferential surface of the development roller 331.

(3. Structures of Regulating Blade 334 and Development Roller 331) Hereinafter, structures of the regulating blade 334 and the development roller 331, which are characteristic features in the development part 33 of the present embodiment, will be described. The thin layer stripe caused by the toner adhesion to the regulating blade 334 described above is in close contact with surface roughness of the tip end portion 334b of the regulating blade 334 and the development roller 331, and a nip width W between the regulating blade 334 and the development roller 331 (a contact width in the circumferential direction).

Then, a relationship between surface roughness of the regulating blade 334 and the development roller 331 and occurrence of the thin layer stripe was checked. As a test method, the occurrence of the thin layer stripe on the development roller 331 and the toner thin layer unevenness were visually observed when an arithmetic average roughness Ra of the surface of the tip end portion 334b of the regulating blade 334 and a ratio (Rz/Sm) of an average interval Sm of the convex and concave portions of the development roller 331 to a ten-point average roughness Rz of the development roller 331 was changed.

As the development roller 331, a roller (manufactured by NICS) was used, which has the roller part 331b made of a silicone rubber layer having a layer thickness of 3.5 mm coated with urethane as a base material layer and having an outer diameter of 13 mm, an axial length of 232 mm, a hardness of 45° and a resistance value of 7.1 [log Q], and the rotational shaft 331a having a shaft diameter of 6 mm. A linear speed of the development roller 331 was set to 195 mm/sec. The hardness was measured using a micro rubber hardness meter (MD-1, manufactured by Polymer Instruments Inc.). The resistance value was measured by bringing the development roller 311 into contact with a metal roller, rotating it, and applying a DC voltage of 100 V.

The material of the regulating blade 334 is SUS 304, and the free length of the regulating blade 334 is 10 mm. The tip end portion 334a of the regulating blade 334 is subjected to a bending to form a curved part 334c. The curved part 334c comes into contact with the outer circumferential surface of the development roller 331. A radius of curvature of the curved part 334c is 0.1 mm or more.

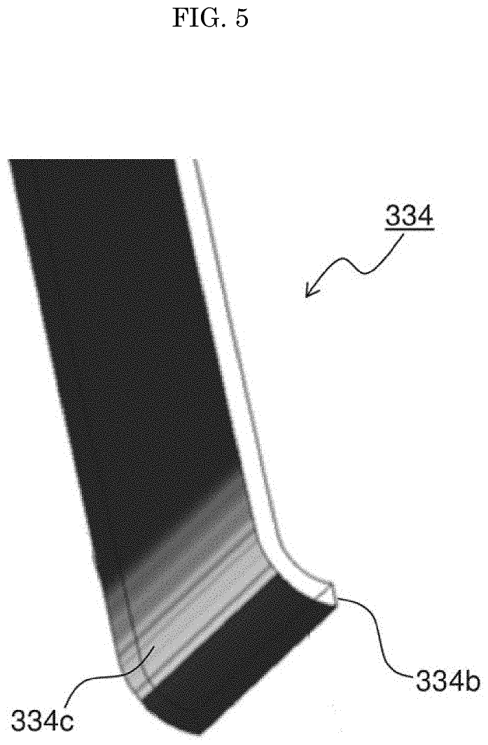

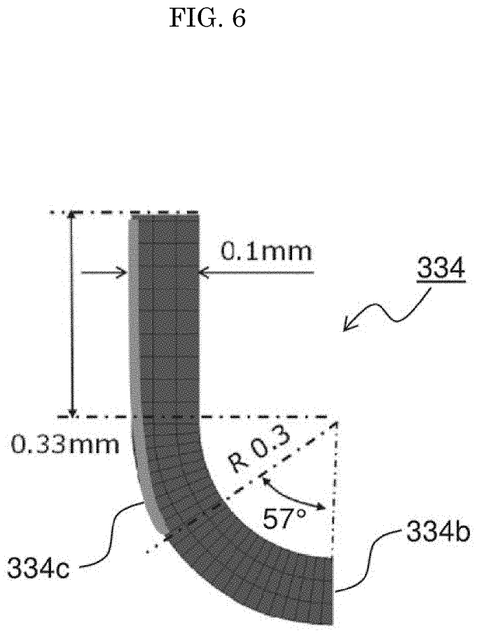

FIG. 5 and FIG. 6 are perspective view and side view, respectively, showing a result of nonlinear analysis of the curved part 334c of the regulating blade 334. As shown in FIGS. 5 and 6, the surface roughness of the regulating blade 334 is different between the portion (the curved part 334c) to which the bending is subjected and the portion to which the bending is not subjected, and the portion to which the bending is subjected has a larger surface roughness due to the R-working strain. In order to make the surface roughness of the regulating blade 334 including the curved part 334c finer, it is necessary to polish the curved part 334c. In this embodiment, a buffing process is performed as an example of the polishing process. A radius of curvature R of the curved part 334c was 0.3 mm.

The surface roughness of the curved part 334c of the regulating blade 334 was measured using a surface roughness measuring machine (S-3100, manufactured by Mitutoyo), and the measurement conditions were set to JIS Standard 2001 (a measurement length of 4.8 mm, a cutoff of 0.8 mm, and a measurement speed of 0.5 mm/sec).

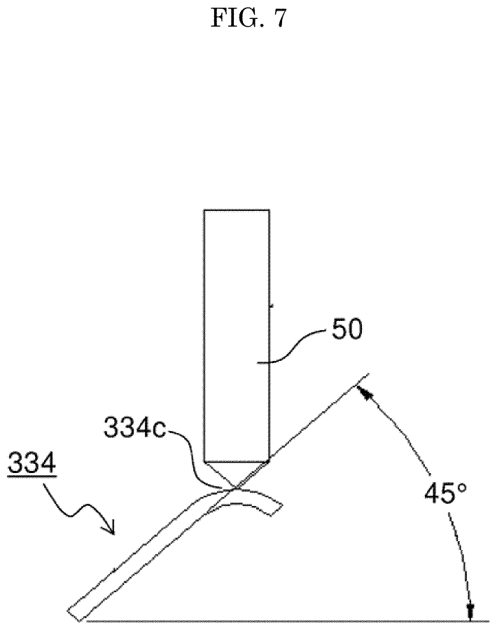

FIG. 7 is a view showing a method for measuring the surface roughness of the regulating blade 334. As shown in FIG. 7, the regulating blade 334 is fixed at an angle of 45°, and a probe 50 is brought into vertical contact with a measuring point (the curved part 334c) from the upper side. The measurement angle of the regulating blade 334 is not limited to 45° as long as it is an angle at which the surface roughness of the curved part 334c can be measured. The regulating pressure (the contact line pressure) was adjusted by changing a biting amount of the regulating blade 334 into the development roller 331 and a thickness of the regulating blade 334.

The toner is a polyester toner having a central particle diameter of 6.8 μm, a circularity of 0.96 and a melt viscosity of 200,000 Pa·s at 90° C., and produced by a pulverization method. The central particle diameter was measured using a particle size distribution meter (LS-230, manufactured by Beckman Coulter). The circularity was measured using a wet type flow particle size and shape analyzer (FPIA-3000, manufactured by Sysmex). The melt viscosity was measured using a flow tester (CFT-500EX, manufactured by Shimadzu Corporation).

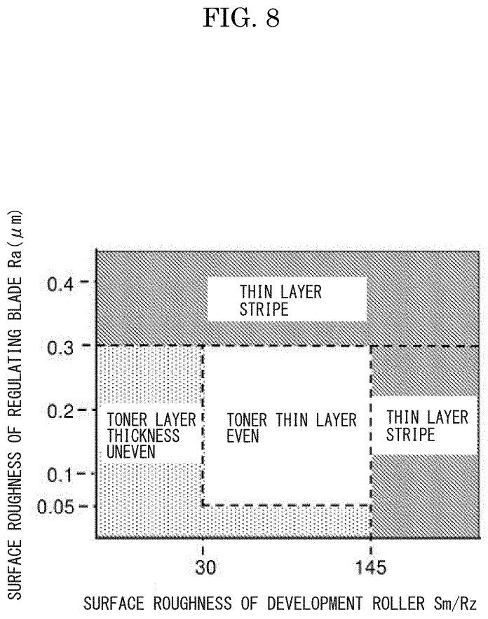

FIG. 8 is a view showing a relationship between a Ra of the regulating blade 334 and a Sm/Rz of the development roller 331, and the thin layer stripe and the toner thin layer unevenness. As shown in FIG. 8, when the arithmetic average roughness Ra of the curved part 334c of the regulating blade 334 is 0.3 μm or more, the thin layer stripe occurs due to the toner adhesion to the regulating blade 334. On the other hand, when the arithmetic average roughness is 0.05 μm or less, the toner layer unevenness occurs. Therefore, by setting the arithmetic average Ra of the curved part 334c of the regulating blade 334 to 0.05 to 0.3 μm, both the thin layer stripe and the toner thin layer unevenness can be suppressed.

Further, by setting the ten-point average roughness Rz of the surface of the development roller 331 to 2 to 4 μm, the variation in durability of the development performance is suppressed. By setting the average interval Sm of the convex and concave portions to 120 to 290 μm and a ratio (Rz/Sm) of the average interval Sm of the convex and concave portions to the ten-point average roughness Rz to a range of 30 to 145, a suitable image density can be secured.

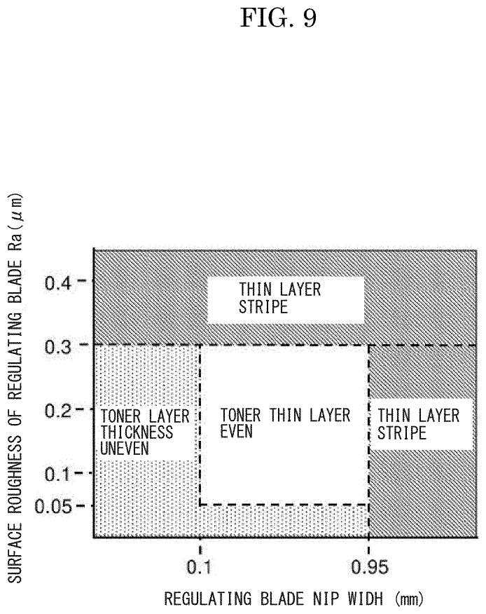

FIG. 9 is a view showing a relationship between a Ra of the regulating blade 334 and a nip width between the regulating blade 334 and the development roller 331, and the thin layer stripe and the toner layer unevenness. The nip width was measured in the manner in which a contact area between the regulating blade 334 and the development roller 331 was colored with a marker, the development roller 331 is rotated while coming into contact with the regulating blade 334 and a width of the colored area scraped by the polishing agent contained in the toner was measured.

As shown in FIG. 9, when the nip width between the regulating blade 334 and the development roller 331 is 0.1 mm or less, the stable toner thin layer is not formed and the toner thin layer unevenness occurs. On the other hand, when the nip width is 0.95 mm or more, the thin layer stripe occurs. Therefore, by setting the nip width between the regulating blade 334 and the development roller 331 to a range of 0.1 to 0.95 mm, both the toner layer stripe and the toner thin layer unevenness can be suppressed.

As described above, the stress applied to the toner is varied depending on the regulating pressure of the regulating blade 334. When the regulating pressure is 60 N/m or more, the regulating pressure is too strong, and the thin layer stripe occurs. On the other hand, when the regulating pressure is 10 N/m or less, the regulating pressure is too weak, and the stable toner thin layer is not formed, and the toner thin layer unevenness occurs. Therefore, by setting the regulating pressure (the liner contact pressure) of the regulating blade 334 to 10 to 60 N/m, both the thin layer stripe and the toner thin layer unevenness can be suppressed.

As described above, by setting the surface roughness of the regulating blade 334 and the development roller 331, the nip width and the regulating pressure to the above ranges, it becomes possible to suppress the toner adhesion to the regulating blade 334 and the thin layer stripe caused by the toner adhesion effectively even in the toner having a relatively low melting point without accompanied with the change in design, such as a change in material of the regulating blade 334, and the increasing in cost.

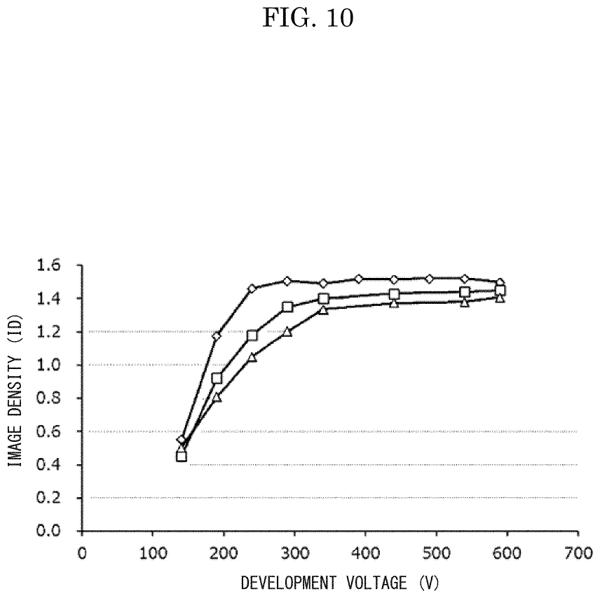

(4. Another Structure) FIG. 10 is a graph showing a relationship between a development voltage applied to the development roller 331 and an image density (ID) when a surface free energy of the development roller 331 is changed. The surface free energy corresponds to a surface tension of a liquid in a solid, and corresponds to a molecular energy of the surface of the solid. In FIG. 10, a case where the surface free energy of the development roller 331 is 12 mJ/m² is represented by the data series of ⋄, a case where the surface free energy is 21 mJ/m² is represented by the data series of □, and a case where the surface free energy is 30 mJ/m² is represented by the data series of Δ.

As shown in FIG. 10, a usable range OW of the development voltage tends to become narrower as the surface free energy of the development roller 331 increases. This is because, as the surface free energy of the development roller 331 increases, the upper limit value of the pressing force of the development roller 331, at which the white void occurs in the half-tone image, decreases. The surface free energy of the development roller 331 is preferably 5 mj/m² or more and 27 mj/m² or less.

An amount of the toner regulated by the regulating blade 334 also varies depending on a contact area ratio of the outer circumferential surface of the development roller 331. The contact area ratio of the outer circumferential surface of the development roller 331 is a ratio of the area of the outer circumferential surface of the development roller 331 excluding the concave area (the non-contact area) to the area of the outer circumferential surface of the development roller 331. That is, the contact area ratio of the outer circumferential surface of the development roller 331 shows a true contact area with respect to an apparent contact area between the outer circumferential surface of the development roller 331 and the regulating blade 334. The contact area ratio is preferably 4.5 to 10%, and more preferably 6 to 8%.

A regulating pressure of the regulating blade 334 is preferably 10 to 60 N/m, and more preferably 15 to 25 N/m. The producing method of the development roller 331 is not particularly limited, and the surface roughness of the development roller 331 may be adjusted by coating a coating layer containing particles or may be adjusted only by polishing.

In the present embodiment, the toner (the pulverized toner) produced by a pulverizing method is used, but the toner (the polymerized toner) produced by a polymerization method can also be used. The polymerized toner has a low rolling resistance because of its true spherical shape having a high circularity, and has a higher durability against the adhesion to the regulating blade 334 and the occurrence of the thin layer stripe because of low stress at the regulating area. Therefore, the present disclosure is particularly effective in the non-magnetic one-component development system using the pulverized toner, which is more inexpensive than the polymerized toner.

In the present embodiment, the central particle diameter of the toner is 6.8 μm, but the results shown in FIG. 8 and FIG. 9 confirm that the similar results can be obtained in the range of the central particle diameter of 6.0 to 8.0 μm. The reason for selecting the range of the central particle diameter is that the central particle diameter smaller than 6.0 μm leads to an increase in the producing cost of the toner, and the central particle diameter larger than 8.0 μm increases the toner consumption amount and deteriorates the fixing performance, which is undesirable.

In the present embodiment, the circularity of the toner is 0.96, but the results shown in FIG. 8 and FIG. 9 confirm that the similar results are obtained in the range of circularity of 0.93 to 0.97. When the circularity is 0.93 or less, the image quality tends to deteriorate. When the circularity is 0.97 or more, the producing cost is significantly increased. Therefore, the both cases are not preferable.

In the present embodiment, the hardness of the development roller 331 is set to 45°, but the results in FIG. 8 and FIG. 9 confirm that the similar results are obtained in the range of hardness of the development roller 331 of 40 to 60°. When the hardness of the development roller 331 is 40° or less, the pressing mark remains due to permanent deformation at pressing areas to the photosensitive drum 31 and the regulating blade 334. This causes a problem in quality. When the hardness of the development roller 331 is 60° or more, the stress applied to the toner increases suddenly, and a possibility of occurrence of the thin layer stripe increases suddenly.

Further, in the present embodiment, a polyester having a melt viscosity of 200,000 Pa·s at 90° C. was used as the main resin constituting the toner, but the results shown in FIG. 8 and FIG. 9 confirm that the similar results can be obtained in the range of melt viscosity of 10,000 to 250,000 Pa·s at 90° C. When the melt viscosity is 250,000 Pa·s or more, the fixing performance of the toner deteriorates, which is undesirable from the viewpoint of energy saving.

In addition, the present disclosure is not limited to the above embodiments, and various modifications can be made without departing from the spirit of the present disclosure. For example, although the monochrome printer has been described as an example of the image forming apparatus 1 in the above embodiment, it can also be applied to a tandem type or a rotary type color printer, for example. The present invention is also applicable to an image forming apparatus such as a copy machine, a facsimile machine, or a multifunction peripheral having these functions. However, they need to be provided with the photosensitive drum 31 and the development part 33 of the non-magnetic one-component development type.

Although the photosensitive drum 31 in the above embodiment uses a cylindrical raw tube as a support, a support of another shape may be used. The other shape may contain a plate shape or an endless belt shape. Further, although amorphous silicon is used as the photosensitive layer of the photosensitive drum 31 in the above embodiment, for example, the photosensitive drum may have a charge injection blocking layer for blocking injection of charges from the support.

The present disclosure is applicable to an image forming apparatus provided with a development device of a non-magnetic one-component development type using a non-magnetic toner. By utilizing the present disclosure, it is possible to provide a development device capable of effectively suppressing the layer unevenness of the toner layer while suppressing the toner adhesion to the surface of the regulating blade and the image forming apparatus provided with the development device.

1. A development device comprising:
a development container containing a non-magnetic one-component developer consisting of a toner only;
a developer carrier having a roller part carrying the toner on an outer circumferential surface and a rotational shaft disposed around an axis of the roller part, and coming into pressure contact with an image carrier at a predetermined pressing force; and
a regulating blade coming into contact with the outer circumferential surface of the roller part of the developer carrier and regulating a thickness of a toner layer formed on the outer circumferential surface of the roller part, and
the development device is configured to supply the toner to the image carrier on which an electrostatic latent image is formed, wherein
the regulating blade has a curved part having a radius of curvature of 0.1 mm or more and coming into contact with the roller part,
the curved part has an arithmetic average roughness Ra of 0.05 to 0.3 μm,
the roller part has a ten-point average roughness Rz of 2 to 4 μm,
the roller part has a concave and convex portion, and an average interval Sm between the concave portion and the convex portion is 120 to 290 μm,
a Sm/Rz is 30 to 145, and
a width of a nip area between the regulating blade and the roller part in a circumferential direction of the roller part is 0.1 to 0.95 mm.

2. The development device according to claim 1, wherein
a contact linear pressure of the regulating blade to the roller part is 10 to 60 N/m.

3. The development device according to claim 1, wherein
the toner is a pulverized toner produced by a pulverizing method.

4. The development device according to claim 1, wherein
the toner has a central particle diameter of 6.0 to 8.0 μm.

5. The development device according to claim 1, wherein
the toner has a circularity of 0.93 to 0.97.

6. The development device according to claim 1, wherein
the toner has a melt viscosity of 10,000 to 250,000 Pa·s at 90° C.

7. The development device according to claim 1, wherein
the developer carrier has a free surface energy of 5 mj/mm² or more to 27 mj/mm² or less.

8. The development device according to claim 1, wherein
a ratio (a contact area ratio) of an area of the circumferential surface of the developer carrier excluding a concave area (a non-contact area) to an area of the circumferential surface of the developer carrier is 4.5 to 10%.

9. The image forming device according to claim 1, wherein
the regulating blade comes into contact with the roller part from a downstream side of a rotational direction of the developer carrier.

10. An image forming apparatus comprising the development device according to claim 1.
